(19) United States
(12) Patent Application Publication
(10) Pub. No.: US 2020/0326591 A1
(43) Pub. Date: Oct. 15, 2020

(54) ELECTRICALLY-RESPONSIVE INFRARED REFLECTIVE DEVICE

(71) Applicants: South China Normal University, Panyu District, Guangzhou (CN); Shenzhen Guohua Optoelectronics Co., Ltd., Longhua District, Shenzhen (CN); Academy of Shenzhen Guohua Optoelectronics, Longhua District, Shenzhen (CN)

(72) Inventors: Guofu ZHOU, Panyu District, Guangzhou (CN); Xiaowen HU, Panyu District, Guangzhou (CN); Wei ZHAO, Panyu District, Guangzhou (CN); Weijie ZENG, Panyu District, Guangzhou (CN)

(21) Appl. No.: 16/498,733

(22) PCT Filed: Oct. 10, 2018
(86) PCT No.: PCT/CN2018/109631

§ 371 Date: Sep. 27, 2019

(30) Foreign Application Priority Data
Jan. 25, 2018 (CN) 201810071347.3

(51) Int. Cl. G02F 1/1335; G02F 1/137; G02F 1/1334; C08F 2/50; C08K 5/07; C08K 5/3475; C08F 222/20

(52) U.S. Cl. CPC G02F 1/133553; G02F 1/13718; G02F 1/1334; C08F 2/50; C08K 5/07; C08K 5/3475; G02F 2202/06; G02F 2203/02; G02F 2001/13775; G02F 2001/13706; G02F 2203/11; G02F 2202/023; C08F 222/20

(57) ABSTRACT

An electrically-responsive infrared reflective device filled with positive liquid crystals, a chiral doping agent, a light absorbing agent and a polymer network. The light absorbing agent is capable of causing a gradient change in light intensity in the filled area irradiated by ultraviolet light, so that the concentration of the polymer network changes in a gradient, thereby forming a gradient of pitch of the positive liquid crystal helix structure. When a power supply voltage is applied, the long axis of the positive liquid crystal will rotate in a direction parallel to the electric field. Since the anchoring effect of the polymer network on the liquid crystals decreases with the decrease of the concentration of the polymer network, the pitch of the positive liquid crystals is gradually damaged, such that the infrared reflection bandwidth of the infrared reflective device gradually reduces from a long wavelength to 0 nm.

### TECHNICAL FIELD

The present disclosure relates to an infrared reflective device, and in particular to an electrically-responsive infrared reflective device.

### BACKGROUND

People generally work indoors, and the comfort of the indoor environment has a great impact on people's enthusiasm for work. In order to achieve sunlight transmission and reflection, the surface of glass is generally coated with one or more layers of films composed of a metal such as chromium, titanium or stainless steel or a compound thereof, which have appropriate transmittance for visible light and a high reflectivity for near-infrared rays. However, after the coated glass is molded, the optical properties cannot be changed, and thus it cannot meet the needs of people. Therefore, there is a need to develop an infrared reflective device that can be dynamically regulated, so as to better meet people's needs. CN106646985 discloses an infrared reflective device in which a helix structure is formed using negative liquid crystal, and the specific helix structure reflects a wavelength band of infrared light having a specific wavelength. The polymer network in the device can capture impurity cations, thereby driving the negative liquid crystal to move, so that the pitches of the negative liquid crystal changes, causing the infrared reflection bandwidth to be widened from narrow. The working principle of the infrared reflective device is that the polymer network can capture impurity cations to reflect infrared light. Therefore, under the effect of an electric field, the impurity cations and thus the polymer network can be pulled to move, thereby driving the negative liquid crystal to move, causing the infrared reflection bandwidth of the device to be widened. When no electric field is applied, the polymer network still captures impurity cations to reflect infrared light. Therefore, such an infrared reflective device always has a reflection bandwidth, which is a drawback when no infrared reflection is needed.

### SUMMARY

In order to solve the above technical problems, the present disclosure provides an electrically-responsive infrared reflective device having an infrared reflection bandwidth that can be tuned to zero.

The technical solution of the present disclosure is described as follow:

Provided is an electrically-responsive infrared reflective device, comprising a first light transmissive and conductive substrate and a second light transmissive and conductive substrate disposed opposite to each other, wherein a pair of parallel alignment layers is disposed on the opposing surfaces of the first light transmissive and conductive substrate and the second light transmissive and conductive substrate, an adjustment area is formed between the first light transmissive and conductive substrate and the second light transmissive and conductive substrate through encapsulation, wherein the adjustment area is filled with a liquid crystal mixture comprising a positive liquid crystal, a chiral doping agent, a light absorbing agent and a polymer network; and the polymer network is formed by a polymerization reaction of polymer monomers initiated by a photoinitiator under ultraviolet light. The light absorbing agent is capable of causing a gradient change in the light intensity of the ultraviolet light in the filled area, leading to a gradient change in the concentration distribution of the polymer network. The positive liquid crystal forms a helix structure in the presence of the chiral doping agent. In a state where the first light transmissive and conductive substrate and the second light transmissive and conductive substrate are connected to a power source, the positive liquid crystals from the side far away from the ultraviolet light to the side close to the ultraviolet light gradually turn the directions thereof, so that the pitch of the helix structure is gradually damaged.

Preferably, the positive liquid crystal is E7 or HTW138200-100.

Preferably, the light absorbing agent is Tinuvin-328.

Preferably, the polymer monomer is selected from any one of RM82, RM257, HCM-024, HCM-025.

More preferably, the chiral doping agent is selected from any one of S811, R811, S1011, R1011.

More preferably, the photoinitiator is Irgacure-651 or Irgacure-369.

Preferably, the mass ratio of the positive liquid crystal:the chiral doping agent:the polymer monomer:the photoinitiator:the light absorbing agent is (70-87.3):(3.6-16.7) : (5-10):(0.5-1.5):(0.8-1.8).

Preferably, the power source is an AC (alternating current) power source.

Preferably, the polymer network is non-responsive in an alternating electric field generated by the AC power source.

The advantages of the present disclosure are presented as follows:

The present disclosure provides an electrically-responsive infrared reflective device which is filled with a positive liquid crystal, a chiral doping agent, a light absorbing agent and a polymer network; wherein the polymer network is formed by a polymerization reaction of polymer monomers initiated by a photoinitiator under ultraviolet light. When the infrared reflective device is illuminated by the ultraviolet light from one side of a light transmissive and conductive substrate, the polymerization reaction of polymer monomers is initiated by a photoinitiator under ultraviolet light to form a polymer network. The light absorbing agent is capable of causing a gradient change in the light intensity of the ultraviolet light in the filled area, wherein the shorter distance from the ultraviolet light source, the stronger the light intensity, and the farther away from the ultraviolet light source, the weaker the light intensity, thus the polymerization rate of the polymer monomers closer to the ultraviolet light source is faster than the polymerization rate of the polymer monomers farther away from the side of the ultraviolet light source. Thereby, a difference in polymer monomer concentrations is produced in the infrared reflective device. The polymer monomers farther away from the ultraviolet light source move toward the side closer to the ultraviolet light source, leading to a gradient change in the concentration distribution of the polymer network. The concentration of the polymer network decreases in a gradient from the side closer to the ultraviolet light source to the side farther away from the ultraviolet light source. The positive liquid crystal forms a helix structure in the presence of the chiral doping agent. The positive liquid crystal is dispersed in the polymer network, and the concentration gradient of the polymer network results in that the length of pitch of the positive liquid crystal helix structure is distributed in a gradient, and thus a wide bandwidth of reflective infrared light can be obtained. Since the concentration of the polymer network is distributed in a gradient, the anchoring effect of the polymer network on the positive liquid crystal on the side farther away from the ultraviolet light source is smaller, and the anchoring effect of the polymer network on the positive liquid crystal on the side closer to the ultraviolet light source is greater. In a state where the first light transmissive and conductive substrate and the second light transmissive and conductive substrate are connected to a power source, the direction of the long axis of the positive liquid crystal molecule on the side far away from the ultraviolet light source turns 90° to be parallel to the direction of the electric field, causing the pitch of the positive liquid crystal helix structure to be damaged, as a result the infrared light cannot be reflected. In contrast, the positive liquid crystal molecules on the side close to the ultraviolet light source are subjected to a great anchoring effect of the polymer network and thus no change in direction occurs. At this time, the reflection bandwidth in the long wavelength band of the infrared reflective device will be reduced. As the supplied voltage is gradually increased, the electric field applied to the positive liquid crystal is gradually increased, and the positive liquid crystal from the side far away from the ultraviolet light source to the side close to the ultraviolet light source gradually turns 90°, thereby the pitch is gradually damaged from the side far away from the ultraviolet light source to the side close to the ultraviolet light source, so that the infrared reflection bandwidth of the infrared reflective device is gradually reduced from the long wavelength band to a reflection bandwidth of 0 nm. By controlling the voltage of the power supply, the change of the pitch structure of the positive liquid crystal can be controlled to adjust the infrared reflection bandwidth. The electrically-responsive infrared reflective device of the present disclosure can overcome the defect in the prior art that the infrared reflection bandwidth cannot be reduced to zero, and thus has good application prospects.

### BRIEF DESCRIPTION OF THE DRAWINGS

FIG. 1 is a structural diagram of the liquid crystal cell;

FIG. 2 is a structural diagram of the electrically-responsive infrared reflective device of the present disclosure;

FIG. 3 is a working structural diagram of the infrared reflective device when connected to low AC power supply voltage; and

FIG. 4 is a working structural diagram of the infrared reflective device when connected to high AC power supply voltage.

### DETAILED DESCRIPTION

The concept, the specific structures, and the technical effects of the present disclosure are clearly and sufficiently described in the following detailed description and figures of the present disclosure for full understanding of the objects, features and effects of the present disclosure. It is apparent that the described examples are only part of the embodiments of the present disclosure, and not all of the embodiments. Based on the embodiments of the present disclosure, other embodiments obtained by those skilled in the art without creative efforts belong to the scope of protection of the present disclosure.

### EXAMPLE 1

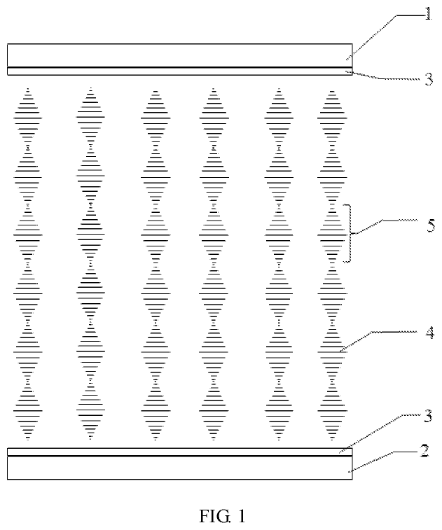

Referring to FIG. 1, the present example provided a liquid crystal cell comprising a first light transmissive and conductive substrate 1 and a second light transmissive and conductive substrate 2 disposed opposite to each other, wherein two parallel alignment layers 3 were disposed oppositely on the surfaces of the first light transmissive and conductive substrate 1 and the second light transmissive and conductive substrate 2. An adjustment area was formed between the first light transmissive and conductive substrate 1 and the second light transmissive and conductive substrate 2 through encapsulation, wherein the adjustment area was filled with a liquid crystal mixture comprising a positive liquid crystal 4, a chiral doping agent, a polymer monomer, a light absorbing agent and a photoinitiator. The positive liquid crystal 4 formed a helix structure in the presence of the chiral doping agent, wherein the helix structure had a pitch 5. In the liquid crystal mixture, the mass ratio of the positive liquid crystal:the chiral doping agent:the polymer monomer:the light absorbing agent:the photoinitiator was 80.2:12.6:5:1.2:1, wherein the chiral doping agent was S811 having a formula:

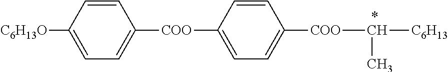

(the carbon atom marked with asterisk “*” meaning a chiral carbon atom); the polymer monomer was RM82 having a formula:

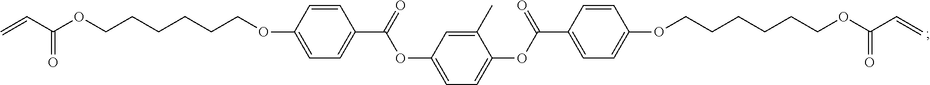 [SMILES: C=CC(=O)OCCCCCCOc1ccc(C(=O)Oc2ccc(OC(=O)c3ccc(OCCCCCCOC(=O)C=C)cc3)c(C)c2)cc1]

the light absorbing agent was Tinuvin-328 having a formula:

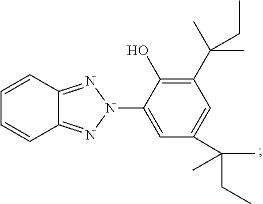 [SMILES: CCC(C)(C)c1cc(-n2nc3ccccc3n2)c(O)c(C(C)(C)CC)c1]

the photoinitiator was Irgacure-651 having a formula:

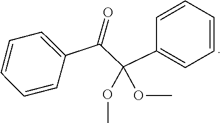 [SMILES: COC(OC)(C(=O)c1ccccc1)c1ccccc1]

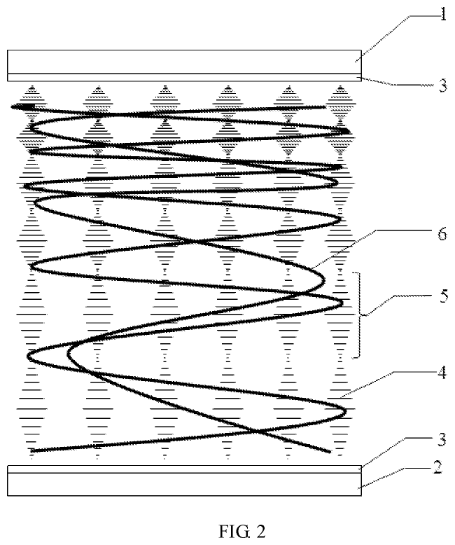

The electrically-responsive infrared reflective device of the present disclosure can be obtained through irradiating the above liquid crystal cell from the side of the first light transmissive and conductive substrate 1 by ultraviolet light, and the structure of the device was shown in FIG. 2. The polymer network 6 was formed by a polymerization reaction of polymer monomers initiated by a photoinitiator under ultraviolet light. The light absorbing agent was capable of generating a gradient change in the light intensity of the ultraviolet light in the filled area, wherein the shorter distance from the ultraviolet light source, the stronger the light intensity, and the farther away from the ultraviolet light source, the weaker the light intensity. Therefore, the polymerization rate of the polymer monomers on the side closer to the ultraviolet light source was faster than the polymerization rate of the polymer monomers on the side farther away from the ultraviolet light source. Thereby, a difference in polymer monomer concentration was produced in the infrared reflective device. The polymer monomer on the side farther away from theultraviolet light source moved toward the side closer to the ultraviolet light source, leading to a gradient change in the concentration distribution of the polymer network 6. The concentration of the polymer network decreased in a gradient from the side close to the ultraviolet light source to the side far away from the ultraviolet light source. The positive liquid crystal 4 formed a helix structure in the presence of the chiral doping agent. The positive liquid crystal 4 was dispersed in the polymer network 6, and the concentration gradient of the polymer network resulted in that the pitch 5 of the helix structure of the positive liquid crystal was distributed in a gradient.

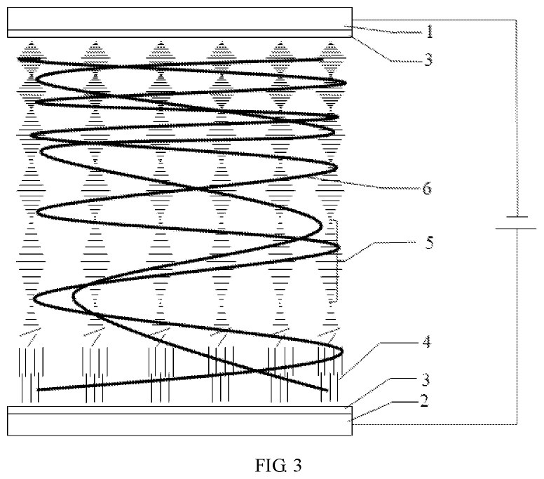

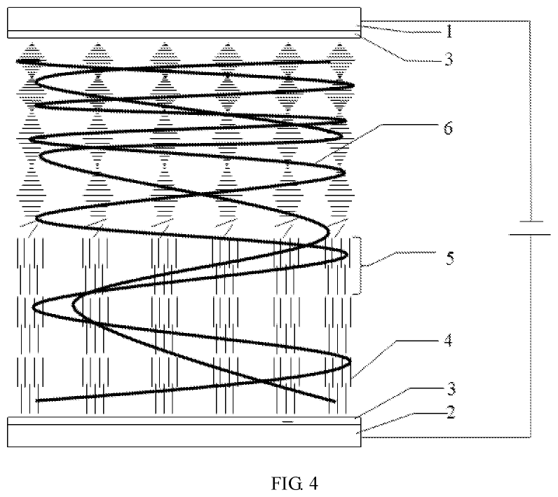

According to the Formula Δλ=(nₑ−nₒ)×P=Δn×P, where nₑ was ordinary refractive index, nₒ was extraordinary refractive index, Δn represented a difference in birefringence, P represented a pitch, Δλ represented reflection spectral bandwidth. It can be seen that due to the presence of the pitch gradient, a wide bandwidth of reflective infrared light can be obtained. Since the concentration of the polymer network 6 was distributed in a gradient, the anchoring effect of the polymer network 6 on the positive liquid crystal 4 on the side farther away from the ultraviolet light source was smaller, and the anchoring force of the polymer network 6 on the positive liquid crystal 4 on the side closer to the ultraviolet light source was greater. Referring to FIGS. 3 and 4, in the state where the first light transmissive and conductive substrate 1 and the second light transmissive and conductive substrate 2 were connected to an AC power source, the direction of the long axis of the positive liquid crystal 4 molecule farther away from the ultraviolet light source turned 90° to be parallel to the direction of the electric field, causing the pitch 5 of the helix structure of the positive liquid crystal 4 to be damaged, as a result, the infrared light cannot be reflected. In contrast, the positive liquid crystal 4 molecule on the side closer to the ultraviolet light source were subjected to a greater anchoring force of the polymer network 6 and therefore no turning in direction occurred. At this time, the reflection bandwidth in the long wavelength band of the infrared reflective device decreased. As the supplied voltage was gradually increased, the positive liquid crystal was subjected to a gradually increased force of the electric field, and the positive liquid crystal 4 from the side far away from the ultraviolet light source to the side close to the ultraviolet light source gradually turned 90°, thereby the pitch 5 was gradually damaged from the side far away from the ultraviolet light source to the side close to the ultraviolet light source, so that the infrared reflection bandwidth of the infrared reflective device was gradually reduced from the long wavelength band to a reflection bandwidth of 0 nm. The bandwidth of the electrically-responsive infrared reflective device of the present disclosure can be reduced starting from a long wavelength. The longer the wavelength of the infrared light, the lower the energy it had. As the supplied voltage increased, the total energy of the infrared reflective device decreased starting from a low energy. The electrically-responsive infrared reflective device of the present disclosure was capable of accurately reflecting infrared light energy, and was more suitable for adjusting indoor temperature.

The infrared reflective device disclosed in CN106646985 had a threshold voltage. The term “threshold voltage” was a voltage under which the polymer network started to be damaged. When the supplied voltage exceeded the threshold voltage, the polymer network was damaged, resulting in that the infrared reflective device cannot work properly. In the present example, AC voltage had no effect on the polymer network and would not damage the positive liquid crystal. Therefore, the electrically-responsive infrared reflective device of the present example had no threshold voltage and thus had a better application prospect.

The above electrically-responsive infrared reflective device was prepared through the following procedure: firstly, a first light transmissive and conductive substrate 1 and a second light transmissive and conductive substrate 2 were prepared, wherein the first light transmissive and conductive substrate 1 and the second light transmissive and light were disposed opposite to each other; the opposing surfaces of the first light transmissive and conductive substrate 1 and the second light transmissive and conductive substrate 2 were spin-coated to form parallel alignment layers 3, and then the parallel alignment layers 3 were orientated by rubbing. A spacer was placed on the edge of the surface of the first light transmissive and conductive substrate 1 provided with the alignment layer 3, and then the second light transmissive and conductive substrate 2 was placed on the spacer. The first light transmissive and conductive substrate 1 and the second light transmissive and conductive substrate 2 were encapsulated to form a liquid crystal cell. The positive liquid crystal, the polymer monomer, the chiral doping agent, the photoinitiator and the light absorbing agent were weighted and placed into a brown bottle, wherein the mass ratio of the positive liquid crystal:the chiral doping agent:the polymer monomer:the light absorbing agent:the photoinitiator was 80.2:12.6:5:1.2:1, thereby a liquid crystal mixture was obtained. The liquid crystal mixture was filled into the liquid crystal cell at a clearing point temperature. When the temperature of the liquid crystal cell was decreased to 35° C., the liquid crystal cell was irradiated by ultraviolet light, thereby obtaining an electrically-responsive infrared reflective device.

### EXAMPLE 2

This present example provided an electrically-responsive infrared reflective device, which was the same as that of example 1, except that: the positive liquid crystal was HTW138200-100, the chiral doping agent was R811 having a similar structure but an opposite chirality with respect to S811, the polymer monomer was RM82, the light absorbing agent was Tinuvin-328, and the photoinitiator was Irgacure-369 having the formula:

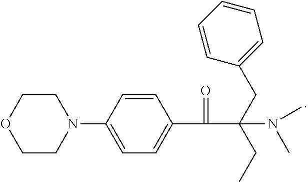 [SMILES: CCC(Cc1ccccc1)(C(=O)c1ccc(N2CCOCC2)cc1)N(C)C]

### EXAMPLE 3

This present example provided an electrically-responsive infrared reflective device, which was the same as that of Example 1, except that: the positive liquid crystal was E7, the chiral doping agent was S1011 having the formula:

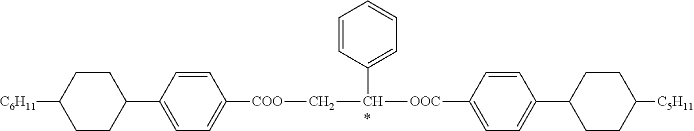

(the carbon atom marked with asterisk “*” meaning a chiral carbon atom); the polymer monomer was RM257 having the formula:

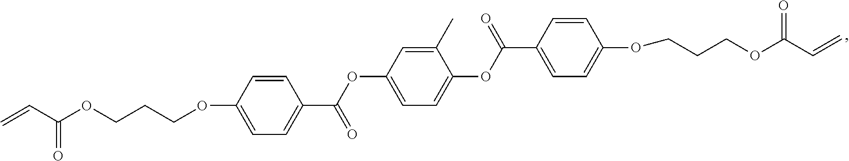 [SMILES: C=CC(=O)OCCCOc1ccc(C(=O)Oc2ccc(OC(=O)c3ccc(OCCCOC(=O)C=C)cc3)c(C)c2)cc1]

the light absorbing agent was Tinuvin-328, and the photoinitiator was Irgacure-651, wherein the mass ratio of the positive liquid crystal:the chiral doping agent:the polymer monomer:the light absorbing agent:the photoinitiator was 86.4:3.9:7.5:1:1.2.

### EXAMPLE 4

This example provided an electrically-responsive infrared reflective device, which was the same as that of Example 1, except that: the positive liquid crystal was E7, the chiral doping agent was R1011 having a similar structure and an opposite chirality with respect to S1011, the polymer monomer was HCM-024 having the formula:

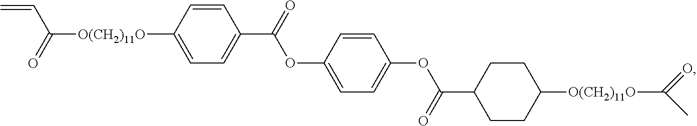

the light absorbing agent was Tinuvin-328, and the photoinitiator was Irgacure-369, wherein the mass ratio of the positive liquid crystal:the chiral doping agent:the polymer monomer:the light absorbing agent:the photoinitiator was 82.7:4:10:1.5:1.8.

### EXAMPLE 5

This example provided an electrically-responsive infrared reflective device, which was the same as that of Example 1, except that: the positive liquid crystal was E7, the chiral doping agent was R1011 having a similar structure and an opposite chirality with respect to S1011, the polymer monomer was HCM-025 having the formula:

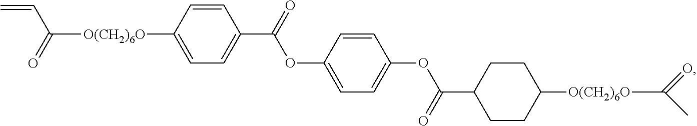

the light absorbing agent was Tinuvin-328, and the photoinitiator was Irgacure-369, wherein the mass ratio of the positive liquid crystal:the chiral doping agent:the polymer monomer:the light absorbing agent:the photoinitiator in the liquid crystal mixture was 87.3:16.7:5:0.5:1.8.

### EXAMPLE 6

This example provided an electrically-responsive infrared reflective device, which was the same as that of Example 1, except that: the positive liquid crystal was E7, the chiral doping agent was R1011 having a similar structure and an opposite chirality with respect to S1011, the polymer monomer was HCM-025, the light absorbing agent was Tinuvin-328, and the photoinitiator was Irgacure-369, wherein the mass ratio of the positive liquid crystal:the chiral doping agent:the polymer monomer:the light absorbing agent:the photoinitiator in the liquid crystal mixture was 70:3.6:10:1.5:0.8.

1. An electrically-responsive infrared reflective device, comprising a first light transmissive and conductive substrate and a second light transmissive and conductive substrate disposed opposite to each other, wherein a pair of parallel alignment layers is disposed on the opposing surfaces of the first light transmissive and conductive substrate and the second light transmissive and conductive substrate, an adjustment area is formed between the first light transmissive and conductive substrate and the second light transmissive and conductive substrate through encapsulation, wherein the adjustment area is filled with a liquid crystal mixture comprising a positive liquid crystal, a chiral doping agent, a light absorbing agent and a polymer network; the polymer network is formed by a polymerization reaction of polymer monomers initiated by a photoinitiator under ultraviolet light.

2. The electrically-responsive infrared reflective device according to claim 1, wherein the positive liquid crystal is E7 or HTW138200-100.

3. The electrically-responsive infrared reflective device according to claim 1, wherein the light absorbing agent is Tinuvin-328.

4. The electrically-responsive infrared reflective device according to claim 3, wherein the polymer monomer is selected from any one of RM82, RM257, HCM-024, and HCM-025.

5. The electrically-responsive infrared reflective device according to claim 4, wherein the chiral doping agent is selected from one of S811, R811, S1011, and R1011.

6. The electrically-responsive infrared reflective device according to claim 5, wherein the photoinitiator is Irgacure-651or Irgacure-369.

7. The electrically-responsive infrared reflective device of claim 1, wherein the mass ratio of the positive liquid crystal:the chiral doping agent:the polymer monomer:the photoinitiator:the light absorbing agent is (70-87.3):(3.6-16.7):(5-10):(0.5-1.5):(0.8-1.8).

8. The electrically-responsive infrared reflective device according to claim 7, wherein the device further comprises an AC power source.

9. The electrically-responsive infrared reflective device according to claim 8, wherein the polymer network is non-responsive in an alternating electric field generated by the AC power source.
